(19) United States
(12) Patent Application Publication
(10) Pub. No.: US 2012/0277931 A1
(43) Pub. Date: Nov. 1, 2012

(54) MICRO CONTROL UNIT FOR PROVIDING STABLE VOLTAGE OUTPUT TO ELECTRIC DEVICE AND SYSTEM FOR PROTECTING ELECTRIC DEVICE

(75) Inventors: Po-Yin Chao, Taipei (TW); Ean-Sue Lee, Taipei (TW); Shui-Chu Lee, Taipei (TW); Shu-Lan Xie, (US)

(73) Assignee: HYCON TECHNOLOGY CORP., Taipei (TW)

(21) Appl. No.: 13/096,170

(22) Filed: Apr. 28, 2011

(51) Int. Cl. G05B 19/00

(52) U.S. Cl. 700/298

(57) ABSTRACT

The present invention is to disclose a micro control unit for an electric device. It includes a charge pump regulator, connected to an external DC power source, for boosting and regulating voltage outputted from the DC power source; and a controller, switched between the external DC power source while a current of the DC power source is stable and the charge pump regulator while the current is unstable, for outputting a stable voltage to the electric device, thereby eliminating damage to the electric device caused by input surge current.

### FIELD OF THE INVENTION

The present invention relates generally to a micro control unit. More particularly, the present invention relates to a micro control unit for providing stable voltage output to an electric device.

### BACKGROUND OF THE INVENTION

Input surge current refers to the maximum, instantaneous input current drawn by an electric device when first turned on. It is generated for the following reason: In the moment the electric device is connected to a power source, since the electric device has been down for a period of time, the power source will instantly charge all components in the electric device with high current. Generally, the situation will last 3 to 10 microseconds. Energy of the input surge current will pass away by radiating from power cables and impact other electronic components. The input surge current brings variation of voltage in use. Therefore, necessary anti-EFT (Electrical Fast Transient) or anti-EMI (Electro-Magnetic Interference) designs have to be available for all electric devices. Of course, they take time to deal with and cost is not negligent.

In the field of electric device, the phenomenon mentioned above does exist. Please refer to FIG. 1. It shows a conventional design of an electric device circuit 10. The electric device circuit 10 is mainly composed of a low voltage DC power source 1, a micro control unit (MCU) 2 and an electric device 3. After receiving the DC power from the DC power source 1, the MCU 2 will provide a voltage output to the electric device 3 to drive a motor (not shown) controlled by the electric device 3. In practice, the MCU 2 is requested to be designed with higher performance against EFT and EMI. In comparison with an ordinary MCU, the higher performance means higher price. It is not widely used.

In order to solve this problem, there are many inventions provided. Please refer to FIG. 2. U.S. Pat. No. 7,112,932 provides a system-on-a-chip (SOC) in complementary metal-oxide-semiconductor (CMOS) technology capable of supporting high voltage applications. The single chip system of the present invention comprises high-voltage circuitry, a complete micro-controller system including all timing control, interrupt logic, flash programmable read-only memory (EEPROM) program memory, random-access memory (RAM), flash EEPROM data memory and I/O necessary to implement dedicated control functions, and a core and system peripheral bus. A preferred embodiment of the invention is shown driving a DC-motor in an H-bridge configuration, having an AMR (anisotropic magneto-resistive)-position detection and control. A pulse width modulation (PWM) is applied to high-voltage (30 to 60 Volts or in lower ranges less than 30 Volts) CMOS buffers for steering CMOS-FETs or relays of the motor H-bridge. Although '932 uses one SOC to settle the problem, it is not available for electric devices under low working voltage.

Another invention is seen in US. Pat. No. 7,586,727. '727 discloses an input surge current limiting power supply switching circuit. It includes a first switch through which an electrical load, having a capacitor, and a direct current power supply are connected, a second switch turned on prior to the first switch when supplying electric power from the direct current power supply to the electrical load, an input surge current limiting circuit connected in parallel to the first switch and having an input surge current limiting resistor connected to the second switch in series, and a monitoring circuit for monitoring a second-switch-shutoff leak current flowing through a diode, connected in series to the second switch in an orientation in which electric power is supplied, when both the first and second switches are off. The feature of '727 is to use the input surge current limiting power supply switching circuit. However, it is not a SOC solution. Meanwhile, the working voltage of '727 is still high for low voltage electric devices.

Last, please refer to FIG. 4. U.S. Pat. No. 7,855,535 shows still another invention related to an anti-inrush-current design. The power supply system comprises a variable voltage source configured to provide and incrementally increase a control voltage associated with a pass-transistor. The power supply system also comprises an input surge current monitor configured to monitor a current-flow through the pass-transistor. The power supply system further comprises a voltage control circuit configured to halt the incremental increase of the control voltage in response to the current-flow exceeding a predetermined current limit. A defect of '535 is that the system needs to be always ON to prevent inrush-current, and thus consumes more power.

According to the discussion above, it is desired to provide a micro control unit for an electric device under low voltage having advantages of: 1. good performance against EMI and EFT caused by input surge current; 2. low power consumption; 3. low manufacturing cost; and 4. integrated design.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a micro control unit for providing stable voltage output to an electric device includes a charge pump regulator, connected to an external DC power source, for boosting and regulating voltage outputted from the DC power source; and a controller, switched between the external DC power source while a current of the DC power source is stable and the charge pump regulator while the current is unstable, for outputting a stable voltage to the electric device, thereby eliminating damage to the electric device caused by input surge current.

Preferably, the charge pump regulator doubles the voltage of the DC power source.

Preferably, the DC power source is a battery.

Preferably, the micro control unit further comprises a determinator for determining whether the current is stable or unstable.

Preferably, the determinator determines the current to be unstable while a surge is detected.

Preferably, determination is performed by software.

Preferably, the stable voltage outputted to the electric device has maximum amplitude of 5 volts.

Preferably, the micro control unit is in form of a micro-processor, a single chip machine, a digital signal processor or a field programmable gate array.

Preferably, the charge pump regulator has a feedback control circuit for generating stable output voltage.

Preferably, the charge pump regulator is further connected to an external capacitor.

In accordance with another aspect of the present invention, a system for protecting an electric device, includes a DC power source for providing a direct current; a micro control unit, comprising: a charge pump regulator, connected to the DC power source, for boosting and regulating voltage outputted from the DC power source; and a controller, switched between the DC power source while the direct current of the DC power source is stable and the charge pump regulator while the direct current is unstable, for outputting a stable voltage; and the electric device, connected to the micro control unit, for receiving the stable voltage outputted from the micro control unit, thereby eliminating damage caused by input surge current.

Preferably, the DC power source is a battery.

### BRIEF DESCRIPTION OF THE DRAWINGS

FIG. 1 shows an electric device of a first prior art.

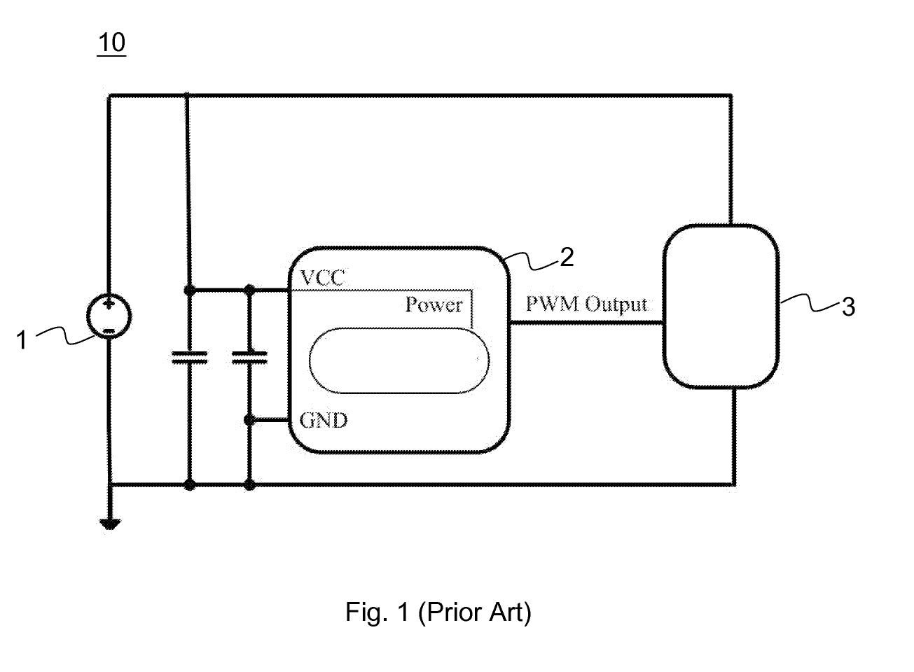

FIG. 2 shows an electric device of a second prior art.

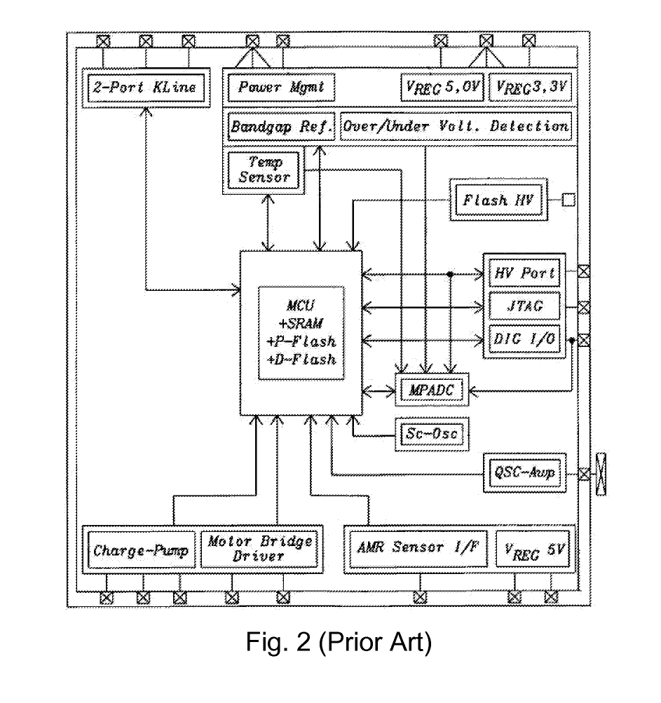

FIG. 3 shows an electric device of a third prior art.

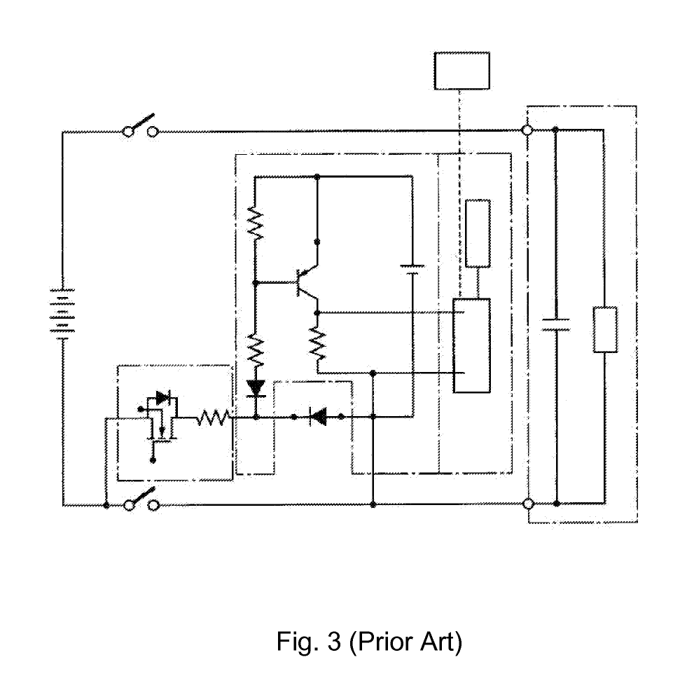

FIG. 4 shows an electric device of a fourth prior art.

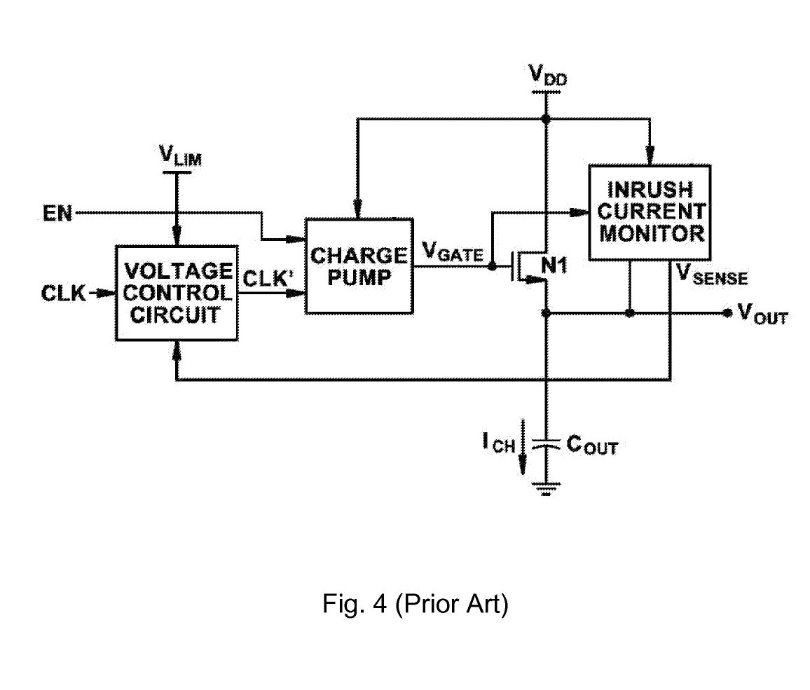

FIG. 5 illustrates a micro control unit of the present invention.

FIG. 6 illustrates a circuit implemented with the micro control unit of the present invention.

### DETAILED DESCRIPTION OF THE PREFERRED EMBODIMENT

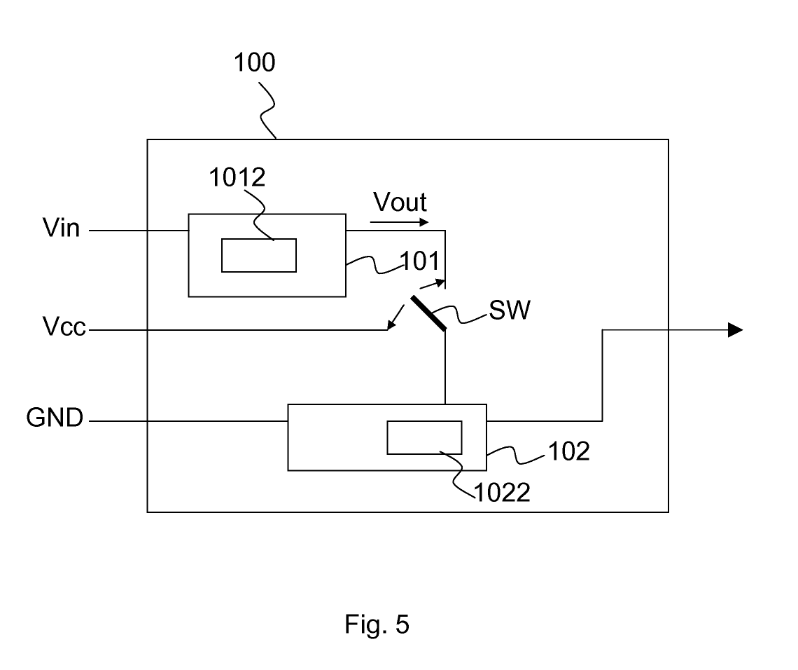

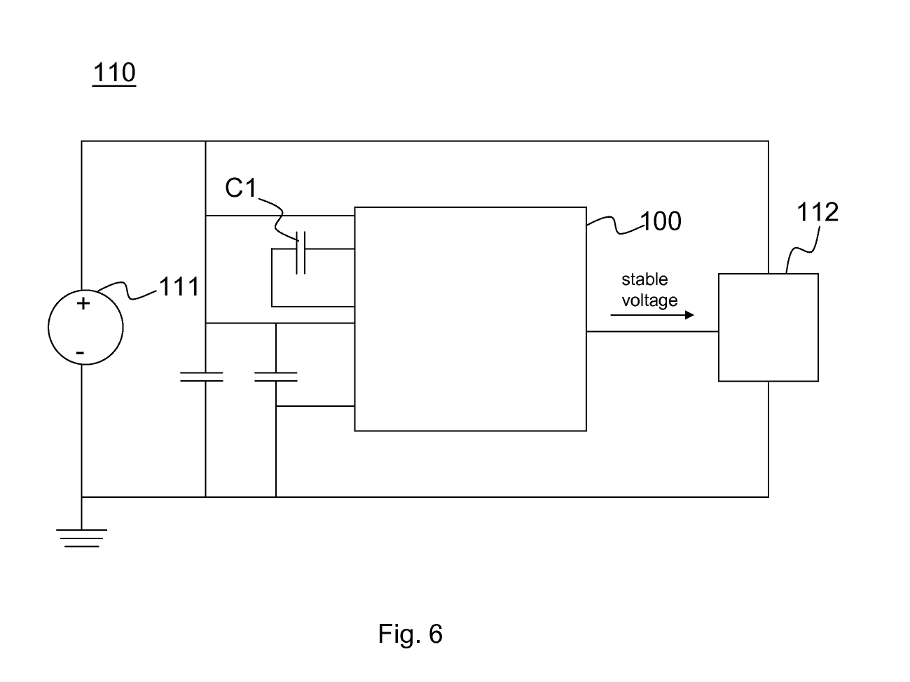

Please refer to FIGS. 5 and 6. FIG. 5 shows a micro control unit 100 of the present invention. FIG. 6 illustrates a circuit 110 implemented with the micro control unit 100. The micro control unit 100 is an integrated circuit (IC). The micro control unit 100 is used to provide steady DC voltage to an electric device 112 under low working voltage.

As shown in FIG. 5, the micro control unit 100 has a charge pump regulator 101, a controller 102, and a switch SW connected between the charge pump regulator 101 and the controller 102. The charge pump regulator 101 receives an input voltage Vin and outputs an voltage Vout to the switch SW. Then, the switch SW passes the voltage Vout to the controller 102.

The charge pump regulator 101 boosts the input voltage Vin into the output voltage Vout before outputting to the switch SW. In this embodiment, the charge pump regulator 101 doubles the voltage Vin of the DC power source 111. Of course, the output voltage Vout of the charge pump regulator 101 is not limited to be double of the input voltage Vin.

Another voltage Vcc can also be directly provided from a DC power source 111 to the controller 102 bypassing the charge pump regulator 101, as shown in FIG. 6. By use of the switch SW, the controller 102 can selectively receive voltage Vout or voltage Vcc. In this embodiment, the controller 102 receives voltage Vcc from the DC power source 111 while a current of the DC power source 111 is stable. Alternatively, the controller 102 receives voltage Vout from the charge pump regulator 101 while the current is unstable.

In other words, when the current of the DC power source 111 becomes unstable, namely, input surge current occurs, the switch SW connects the controller 102 to the charge pump regulator 101 to have steady voltage inputted. Otherwise, the switch SW is usually connected to the DC power source 111 while the current of the DC power source 111 is stable to prevent power lost due to operation of the charge pump regulator 101.

In practice, the controller 102 has a determinator 1022 for determining whether the current of the DC power source 111 is stable or unstable. In detail, the current is determined to be unstable while a surge is detected. The determination of the determinator 1022 can be performed by software. It means that the micro control unit 100 can be adjusted to be suitable for any kinds of electric devices. The charge pump regulator 101 has a feedback control circuit 1012 so that it can generate stable output voltage. The charge pump regulator 101 can even be connected to a capacitor C1 for assisting in voltage boosting and regulating, as shown in FIG. 6.

Furthermore, ground voltage GND of the DC power source 111 is connected to the controller 102, as shown in FIG. 5. The DC power source 111 can be a battery according to the present invention.

Finally, the controller 102 outputs a stable voltage to the electric device 112, thereby eliminating damage to the electric device 112 caused by input surge current.

Usually, the current is considered unstable when the current increases several times of its normal value within a short time. Mainly, the input surge current occurs within 10 ms. The stable voltage has maximum amplitude of 5 volts. In practice, the micro control unit 100 can be in form of a micro-processor, a single chip machine, a digital signal processor or a field programmable gate array.

Although in FIG. 6, the DC power source 111 and the capacitor C1 are included in the circuit 110, it can be externally connected to the micro control unit 100 while the micro control unit 100 is designed as an individual circuit chip.

The present invention can be used for electric devices such as vacuum cleaner, soybean milk machine, air conditioner, refrigerator, washing machine and other electrical products. The invention provides a better anti-interference ability. Developers of those electrical products do not need to deal with electromagnetic radiation interference problems and take mask measures, and therefore, save them a lot of time.

While the invention has been described in terms of what is presently considered to be the most practical and preferred embodiment, it is understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A micro control unit for providing stable voltage output to an electric device, comprising:
a charge pump regulator, connected to an external DC power source, for boosting and regulating voltage outputted from the DC power source; and
a controller, switched between the external DC power source while a current of the DC power source is stable and the charge pump regulator while the current is unstable, for outputting a stable voltage to the electric device, thereby eliminating damage to the electric device caused by input surge current.

2. The micro control unit according to claim 1, wherein the charge pump regulator doubles the voltage of the DC power source.

3. The micro control unit according to claim 1, wherein the DC power source is a battery.

4. The micro control unit according to claim 1, further comprising a determinator for determining whether the current is stable or unstable.

5. The micro control unit according to claim 4, wherein the determinator determines the current to be unstable while a surge is detected.

6. The micro control unit according to claim 4, wherein determination is performed by software.

7. The micro control unit according to claim 1, wherein the stable voltage outputted to the electric device has maximum amplitude of 5 volts.

8. The micro control unit according to claim 1, wherein the micro control unit is in form of a micro-processor, a single chip machine, a digital signal processor or a field programmable gate array.

9. The micro control unit according to claim 1, wherein the charge pump regulator has a feedback control circuit for generating stable output voltage.

10. The micro control unit according to claim 1, wherein the charge pump regulator is further connected to an external capacitor.

11. A system for protecting an electric device, comprising:
a DC power source for providing a direct current;
a micro control unit, comprising:
a charge pump regulator, connected to the DC power source, for boosting and regulating voltage outputted from the DC power source; and
a controller, switched between the DC power source while the direct current of the DC power source is stable and the charge pump regulator while the direct current is unstable, for outputting a stable voltage; and
the electric device, connected to the micro control unit, for receiving the stable voltage outputted from the micro control unit, thereby eliminating damage caused by input surge current.

12. The system according to claim 11, wherein the DC power source is a battery.
